(19) United States
(12) Patent Application Publication
(10) Pub. No.: US 2025/0211702 A1
(43) Pub. Date: Jun. 26, 2025

(54) WIRELESS NETWORKED RECORD SESSION DEVICE

(71) Applicant: FUN IN THERE ENTERTAINMENT LLC, Rehoboth Beach, DE (US)

(72) Inventors: William BOLLMAN, Rehoboth Beach, DE (US); Kevin CARRICO, Royal Oak, MI (US)

(21) Appl. No.: 18/759,926

(22) Filed: Jun. 30, 2024

Related U.S. Application Data
(63) Continuation of application No. 18/222,924, filed on Jul. 17, 2023, now Pat. No. 12,028,640.
Application No. 18/222,924 is a continuation of application No. 17/562,995, filed on Dec. 27, 2021, now Pat. No. 11,792,350.
Application No. 17/562,995 is a continuation of application No. 17/098,670, filed on Nov. 16, 2020, now Pat. No. 11,212,426.
Application No. 17/098,670 is a continuation of application No. 15/283,713, filed on Oct. 3, 2016, now Pat. No. 10,841,462.
(60) Provisional application No. 62/262,580, filed on Dec. 3, 2015.
(60) Provisional application No. 62/239,017, filed on Oct. 8, 2015.
(60) Provisional application No. 62/237,190, filed on Oct. 5, 2015.
(60) Provisional application No. 62/235,842, filed on Oct. 1, 2015.

(51) Int. Cl. H04N 5/222; G10H 1/00; G11B 27/00; G11B 27/031; H04L 67/10; H04N 5/262; H04N 5/91; H04N 9/82

(52) U.S. Cl. CPC H04N 5/2224; G10H 1/0091; G11B 27/00; G11B 27/031; H04L 67/10; H04N 5/91; H04N 9/8205; H04N 9/8211; G10H 2210/145; G10H 2210/155; H04N 5/2621

(57) ABSTRACT

A social entertainment user interface operating on a wireless networked record session device capable of producing a live video and/or audio stream as if made in a vintage record booth. Record sessions are listened to and/or watched by a plurality of other social entertainment user interfaces operating on other networked listening/watching wireless networked devices. Video and audio filters emulate various altered looks and sounds. Record sessions are streamed live or near-live for other social entertainment user interfaces operating on other networked wireless devices to listen and/or watch, and passively and actively rated to dynamically enable watching of the most preferred record sessions.

The present invention is a continuation of U.S. application Ser. No. 18/222,924, filed Jul. 17, 2023, now U.S. Pat. No. 12,028,640; which in turn is a continuation of U.S. application Ser. No. 17/562,995, filed Dec. 27, 2021, now U.S. Pat. No. 11,706,376; which in turn is a continuation of U.S. application Ser. No. 17/098,670, filed Nov. 16, 2020, now U.S. Pat. No. 11,212,426; which in turn is a continuation of U.S. application Ser. No. 15/283,713, filed Oct. 3, 2016, now U.S. Pat. No. 10,841,462; which in turn claims priority from U.S. Provisional No. 62/235,842, filed Oct. 1, 2015;

and from U.S. Provisional No. 62/237,190, filed Oct. 5, 2015; and from U.S. Provisional No. 62/239,017, filed Oct. 8, 2015; and from U.S. Provisional No. 62/262,580, filed Dec. 3, 2015; the entirety of all of which are expressly incorporated herein by reference.

### BACKGROUND OF THE INVENTION

### 1. Field of the Invention

This invention relates generally to a recording studio. More particularly, it relates to a network of recording studios to share recording sessions in a social media format.

### 2. Background of Related Art

The record booth gained prominence during World War II. The most common example was first introduced in 1941 by Mutoscope International with a record booth called a Voice-O-Graph record booth. Several models of the Voice-O-Graph record booth were ultimately manufactured, including a 1941 model, a 1943 model, a 1947 model, a 1957 model, and a late 1960s model.

The Voice-O-Graph enabled a user to insert coinage (e.g., 25 c, 35 c, 50 c) whereby a cardboard based, lacquer coated 78 rpm audio record was made from the live recording session, played back to the user, then vended to them.

The Voice-O-Graph record booth, in its original form, essentially disappeared from the public scene over half a century ago.

### BRIEF DESCRIPTION OF THE DRAWING

Features and advantages of the present invention become apparent to those skilled in the art from the following description with reference to the drawings:

FIG. 1 shows an exemplary record booth session network to provide 45 rpm record making services, in accordance with the principles of the present invention.

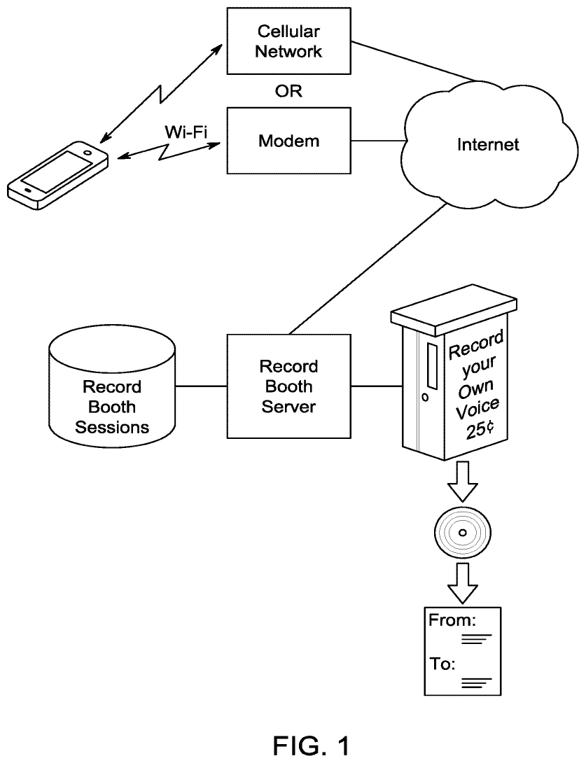

FIG. 2 shows a record booth session network to provide live streaming presentation of record booth sessions to a plurality of listening/watching Smartphone devices, in accordance with the principles of the present invention.

FIG. 3 shows an exemplary user interface operating on a Smartphone, e.g., an iPhone, in accordance with the principles of the present invention.

FIG. 4 shows an exemplary user interface to present a scrolling list of currently live record booth sessions from which to select for listening/watching, in accordance with the principles of the present invention.

FIG. 5 shows an exemplary screen shot of a live record booth session being watched at one of a plurality of listening/watching Smartphone devices, in accordance with the principles of the present invention.

FIG. 6 shows an exemplary life-size record booth built in a style, e.g., of a 1947 Voice-O-Graph record booth, in accordance with the principles of the present invention.

### DETAILED DESCRIPTION OF ILLUSTRATIVE EMBODIMENTS

The present invention improves the functioning of a mobile device such as an iPhone by enabling it organized and optimized creation to create a record booth session, and access to view or listen only, in near real-time, preferred video and audio from multiple external other sources, of limited length, and optimized according to multiple categorizations, while avoiding videos and audio from multiple external sources that are less desirable, or not within a desired categorization, or subject matter.

The invention provides a record booth session network, comprised of a plurality of wireless devices each running an application to operate as a record booth and produce a live video and/or audio record booth session.

The invention improves the operation of a mobile device to filter through video streams from many other mobile devices networked through a record booth sessions network. When creating a limited-length record booth session, the mobile device is improved to enable a user to define a desired channel to store the video in, and within that desired channel a category. The category may either be chosen from a prompted list of the latest trending categories (trending in near-real-time); may be entered manually to perform a search of all current categories; or a new category may be started by that mobile device record booth.

From the perspective of a mobile device in watching or listening mode, the mobile device is improved to enable a record booth to watching or listen to pre-filtered videos or audio according to a set channel, and set category if desired. Preferably, the filtered video stream is presented to the mobile device record booth with individual record booth sessions that are in the set channel, and if categorization filtering is turned on then the record booth video stream is further filtered to present videos in the video stream that meet the selected category. The category within a given channel is set by the record booth mobile device in watching mode by a prompt of, e.g., the most recently trending categories within that channel; or the user can enter a search term and search all categories for a desired category.

The result provides an mobile device that is improved to present an entertainment network including multiple channels, each channel being focused by settings in the record booth mobile device (if desired) to a selected category of videos, thus providing a custom video stream containing only desired video from many other record booth mobile devices all concatenated into a single video stream such that only video of desired content is transmitted to the record booth mobile device by the record booth sessions network.

The record booth session network provides a new type social media/entertainment media that forms a modern take on entertainment. The record booth session network self-generates an entertainment stream (video or just audio) for people to watch/listen to, all fueled by weekly sponsored contests to generate the most popular 65 second record booth session. An hour's worth of the day's best record booth sessions are looped in one entertainment stream (video or audio) and the week's best are looped in another entertainment video/audio stream. A new ‘watcher’ of the record booth session network is immediately thrust into watching the very best entertainment stream (the weeks best), or dig deeper and watch the day's best entertainment stream, or search for favorite record booths to watch. They can go as deep into the streams as they want. The record booth session network self-generates a stream of the very best record booth recordings, and gives access to watch ‘lesser’ entertainment streams.

The record booth session network has built-in incentive to both attract record booth devices to enter that week's contest (for whatever prize), utilizing contest entry tokens, as well as to attract viewers who merely watch the video or audio streams formed by record booth sessions as self-generating, and self-organizing, entertainment.

Sponsor branding videos may be injected into the entertainment streams generated during a given contest within the record booth session network, and revenue from contest entry and token purchases may be shared with sponsors. Moreover, users of wireless record booth devices will be incentivized to self-promote record booth sessions made on their own wireless record booth device, on their own social media channels, to encourage other wireless record booth devices to watch and otherwise contribute to a rating that will automatically promote a given record booth session to a day's best, or a week's best entertainment channel.

Preferably, the user interface of the record booth is a functional depiction of the inside of a particular model of the Voice-O-Graph record booth, e.g., the inside of the 1947 Voice-O-Graph record booth.

To operate the record booth and generate a live record booth session, a user purchases one or more tokens, quarters or other coinage. For instance, a 25 c ‘token’ may be purchased on account and billed to PayPal or whatever. The tokens may be paid for in bulk, e.g., monthly, for efficiency and convenience.

To start the record booth, the user preferably taps a visual depiction of a coin slide or coin entry plate in the graphical user interface showing the inside of a 1947 Voice-O-Graph record booth to ‘insert coin’ and start the record booth.

Preferably, the record booth visually depicts an animation (or actual video) of a record blank being loaded onto the turntable of the relevant model of Voice-O-Graph record booth. Record blanks may be clear plastic. Alternatively, the record blanks may be shown as being black, or any other color or combination of colors.

Visual signals, on the depicted instruction “backglass” of the user interface displayed on the display screen of the wireless device, operate in the wireless record booth similar to the signaling in a real 1947 or 1957 Voice-O-Graph recording studio, including:
GET READY arrow lights;
65 SECONDS TO GO lights, together with RECORDING
WHEN LIT light, etc.;
30 SECONDS TO GO light;
WARNING, 10 SECONDS TO GO light;
STOP! RECORDING COMPLETE light.

Preferably, the record booth sessions are short, e.g., most preferably 65 seconds in length. Most preferably, the length is not sufficient for a typical entire song.

A nixie tube countdown clock may be provided in any suitable time format, e.g., starting at “1:05” counting down to “0:00”; or starting at “65” and counting down to “0”.

### 45 Rpm Record

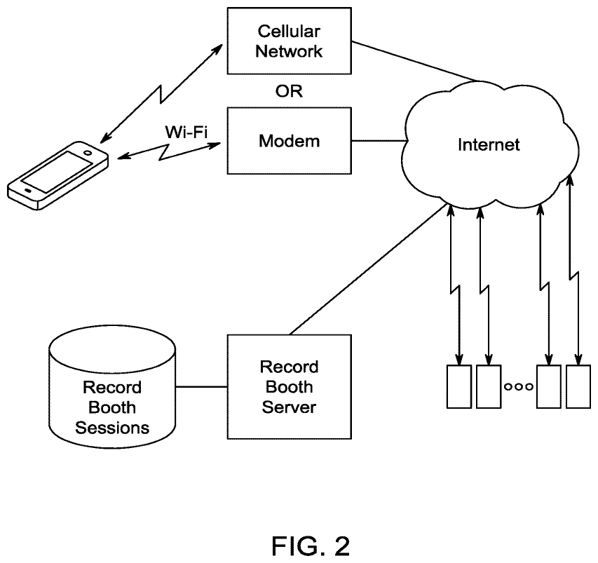

FIG. 2 shows an exemplary record booth session network to provide 45 rpm record making services, in accordance with the principles of the present invention.

In particular, as shown in FIG. 2, an actual ‘direct-to-vinyl’ plastic record may be made from any record booth session, uploaded to a record booth server, stored in a record booth sessions database, queued for cutting on a record lathe or actual record booth in turn by an appropriate technician, then mailed directly to a supplied address. Preferably an additional cost is associated with the making and mailing of an actual record. The records are preferably 45 rpm records, but may be 33⅓ rpm. The records are further preferably 6″ diameter, though 7″ diameter is a possibility. A plurality of different record booth sessions may be concatenated onto a single record, e.g., a 10″ or 12″ LP style record.

Thus, after completion of any given record booth session, a prompt is presented to the user interface asking if they want a 45 rpm record made. If so, appropriate payment would be made or put on account. A visual token may be purchased and entered into the user interface by touch screen commands. Prompts are preferably provided to obtain necessary information such as name and address to send the 45 rpm record to. For efficiency, a last-entered mailing address may be presented to the user for confirmation. Alternatively, the selection of the option to have a 45 rpm record made may be made before the record booth session begins. The selection may be made by selection from a dropdown menu of possibilities, either before or after the record booth session.

An image file may be uploaded to serve as liner notes, and included with the mailed record.

The record booth user interface importantly uses the front-facing camera of the phone to video record the record session. Thus, the video image will typically be of one or more persons singing or speaking in front of the wireless device record booth.

The record booth network preferably includes a social network feature—the record booth 65 second fair use sessions of all app users are streamed LIVE for the masses (per authorized agreement upon initial installation of the Record Booth app in the user's phone).

CONFIGURABLE OPTION: The streams may be audio only, or video with audio.

The Record Booth app provides an opportunity (for those who step into their own personal wireless device record booths) to be heard and/or watched in a social network environment!

### Live Streaming

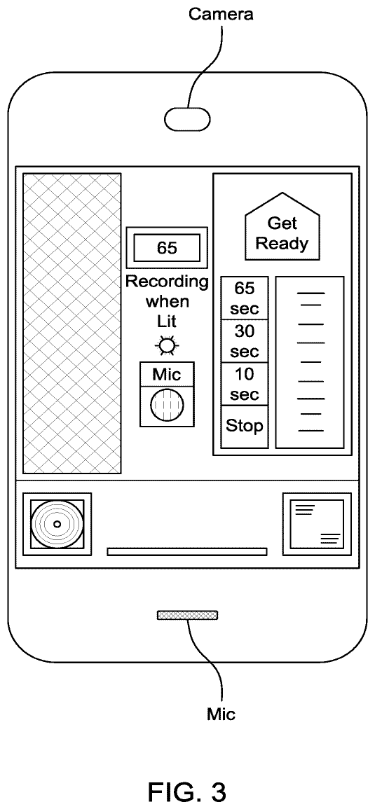

FIG. 3 shows a record booth session network to provide live streaming presentation of record booth sessions to a plurality of listening/watching Smartphone devices, in accordance with the principles of the present invention.

In particular, as shown in FIG. 3, the record booth session is a LIVE video stream uploaded to the Record Booth server—not stored locally on the wireless device then significantly later uploaded by the user. An advantage to this is that it significantly limits use of the record booth in large venues such as concerts as streaming video is a practical impossibility in such a venue because of the limitations of available resources. A disadvantage is that because of the demands of live streaming, video quality and the ability to post-process and edit video may suffer due to video compression. Nevertheless, to the extent that the live video stream must be buffered/stored locally for a short period of time while or just before upload to the Record Booth server, the buffer/storage is made invisible to the user and occurs entirely in the background. A significant delay is avoided between the recording of the record booth session, and upload to the record booth server. Preferably, though not necessarily, post-processing of a record booth session is made difficult for an average user, if at all possible, to preserve the raw and genuine nature of live audio and/or video.

Audio, however, of the record booth session may be saved locally to an audio file that may be located and later played back by the user, serving as a record booth session playback function. As a premium option, video of the record booth session stored (at least temporarily) on the Record Booth server may be made available, for a given amount of time, to the record booth on the Record Booth server.

Preferably, as a configurable option (e.g., as a premium service), the record booth user may download back down the record booth session that was uploaded essentially live. Also, as a configurable option (e.g., as a premium service), the record booth user may be given the ability to search and download from the record booth server, audio and/or video from any other record booth.

After recording a record booth session, that recording record booth preferably displays a queued position, or time to live presentation on a given presentation channel, indicating approximately when the record booth session will be played live to other users.

If there are fewer live record booth sessions than available time to fill, the user device may either mute the audio output during extended periods of time when no live record booth session is currently available for the given channel, or alternatively the user device may return to another audio source from a different application (such as a streaming radio station, etc.) until which time a new live record booth session does become available. Then, the user device will switch the currently output audio source back to audio from the record booth to play the newly live record booth session.

Each Record Booth app is uniquely named by the phone owner. Famous names, trademarked names, etc. are individually verified and indicated to listeners as being certified, e.g., using a check mark aside the record booth name, etc.

A visual LINER NOTE (one sided) may be uploaded through the record booth for display during AUDIO presentation, and/or used as an icon when users are selecting from among available live record booth sessions, etc.

Recordings may be pre-categorized by the person paying the 25 c, for more organized selection by listeners. Categories may include, e.g.:
A CAPELLA
W/INSTRUMENT
SPEAKING
COMEDY
ORIGINAL SONG/SONGWRITERS
   Sub-categories may include, e.g.:
ALL/general
ROCK
POP
COUNTRY
   A general category relating to LANGUAGE of the recording:
ENGLISH, etc.

For an added treat, actual sounds of a real 1947 Voice-O-Graph record booth may be output for realism.

A watermark may be added to the record booth session video stream before presentation to the plurality of listening/watching record booths, thus providing a means for trademarking and/or sponsorship. FIG. 3 shows an exemplary user interface operating on a Smartphone, e.g., an iPhone, in accordance with the principles of the present invention.

### Presentation of Record Booth Sessions

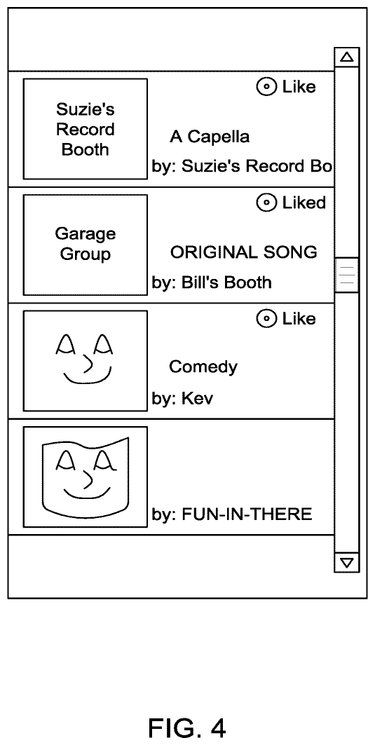

FIG. 4 shows an exemplary user interface to present a scrolling list of currently live streams of record booth sessions from which to select for listening/watching, in accordance with the principles of the present invention.

In particular, as shown in FIG. 4, all current record booth sessions are presented for listening (or viewing) in a suitable streaming channel, selected by a listening/watching record booth, e.g., by use of a scrolling list. A short audio clip of a currently presented record booth session on a given streaming channel may be sampled to aid in the selection. For instance, while a touch screen is contacted in an appropriate area, audio from a designated streaming channel may be played, and ceased upon lifting of the touch on the touch screen. Alternatively, sample audio may be output while executing a deep press on a suitably capable touch screen. If bandwidth permits, sample video may be provided with the sample audio.

Current record booth sessions may be categorized first, then presented on a suitable streaming channel based on their category. Categorization may be input by the user, or in the future automated in some way (distinction between instrument v. a cappella, singing v voice, etc.)

Exemplary categories input by the user may include input the name of a contest category. Contests may be run in any frequency, including once a month, week, day, hour, etc. A contest access code may be implemented to limit entries from any given record booth.

Preferably, the streaming channels present to a listening/watching record booth live record booth sessions, queued one after another, at the end of a currently playing live record booth session. If any record booth session has ended early, or otherwise includes a significantly long silent or blank section, that record booth session may be automatically sensed by the record booth server to terminate the playing of a current record booth session, and start playing of a next-queued record booth session, e.g., after 4 seconds of essentially silence.

As the number of queued live record booth sessions increases, additional streamed channels may be added for selection by listening/watching record booths. The wireless record booth is preferably notified of an identity of a streaming channel, and queued position therein, of when their live record booth session will be played.

A configurable option is to display an exact, or approximate, number of currently listening/watching record booths in total running at that time, and/or a number of listening/watching record booths listening or watching any given streaming channel. The number of currently listening/watching record booths overall, and with respect to each streaming channel, may be displayed for both the recording record booth as well as for the listening/watching record booth. For the recording record booth, preferably the displayed number of listening/watching record booths relates to those listening or watching the streaming channel that the resulting record booth session being is injected into.

Users can ‘favorite’ record booth names on their listening/watching record booth so that when that ‘favorited’ record booth appears in any available streaming channel, the listening/watching record booth will automatically switch to that channel carrying their ‘favorite’ record booth as it begins (preferably a configurable option). In this way, a given listening/watching record booth will be able to listen to/watch all record booth sessions from ‘liked’ record booths.

If the listening/watching record booth is not currently active, yet a record booth session with ‘favorite’ status is about to be played, the wireless device is preferably provided with an out-of-band message such that a text message, tweet, or other notification suggesting that the record booth app be started to hear/watch the upcoming record booth session. Ideally a link is provided with the out-of-band message such that the record booth app may be started and steered to play the ‘favorited’ record booth session with a single click.

In other embodiments, the listening/watching record booth may be able to navigate within the record booth app to view a list of any upcoming record booth sessions of ‘liked’ record booths.

Audio only of default streaming channel may be streamed live to those who select it, for more passive listening. Preferably, a button is presented to switch to video mode as desired within the listening/watching record booth, then another button to switch back to audio only.

Selection of a streaming channel on any given listening/watching record booth may be configured to automatically switch to a streaming channel playing a higher/highest rated record booth session. The automatic selection may preferably utilize, e.g., a last rating of a given record booth session from the relevant record booth, an average of a plurality of recent ratings, etc.

### Individual Artistic Effects

### Record Booth “Skins”

The record booth user interface may emulate any of a plurality of different style vintage record booths. For instance, the disclosed embodiments utilize a record booth “skin” that emulates or evokes an actual 1947 model of the Voice-O-Graph record booth. However, the user interface may present a visual record booth “skin” that emulates or evokes an actual 1957 model of the Voice-O-Graph record booth. Or that emulates or evokes an actual 1960s model of the Voice-O-Graph record booth. Or that evokes an imaginary model of the Voice-O-Graph that was not actually manufactured.

If a different model of the Voice-O-Graph is chosen as the user interface to the hosting wireless device, preferably new mechanism animation associated with that different model of the Voice-o-Graph is visually (and perhaps audibly to include a dropping of the record, etc.) presented to the display of the wireless Record Booth.

### Video Effects

Visual software filter effects may be added to the video of the live record booth session to add any of a plurality of effects to the video. In a preferable embodiment, each, or all, video effect filters may be purchased from the record booth server, or suitable other server or App store, for addition to the relevant wireless device record booth.

For instance, a video filter may be selected that filters the record booth session as a resulting video stream that appears to have been filmed with 35 mm film; or with a vintage film camera; or through a fisheye lens; or to have a sunburnt look; or hot color content; an aged film look; etc. Another video filter preferably renders the video to appear as though it is being played on a 1940s style TV (e.g., black and white, rounded CRT edges, rastered, etc.). The look of other model TVs may also be provided as a video filter, e.g., as a 1960s early color TV (film noir/sound noir, less rounded edges, rastered). A Technicolor/Technisound video/audio filter combination may be associated with a 1970s style TV.

Preferably, as an aid to selection of a particular video filter, the user is provided with an image from the front-facing camera on their smartphone (e.g., iPhone) using a contemplated video filter as they are selecting the given video filter.

### Audio Effects

Different microphones, cutting heads, and even cutting styluses may be selected in a desired combination to emulate a different audio effect. For instance, a bullet harmonica microphone may be selected with limited frequency cutoff response of about 5,500 Hz, or a high fidelity mic such as a 1950s Elvis style microphone may be selected with a particular 16,000 Hz frequency cutoff response point, or any other microphone in between. Ideally the actual frequency response curves of the selected microphone are applied against the audio as a filter. Additional microphone selections may be made available as a premium service, or purchased via interaction with the record booth server or suitable app store.

Additional audio filter options may include a choice of modern HD/5.1 Dolby Digital sound.

Similarly, different cutting heads may be emulated in sound style, with differing frequency capabilities. Additional cutting head selections may be a premium service, or purchased via interaction with the record booth server or suitable app store.

Record surface noises or other subtlties may be added as an audio effect via selection of a particular style cutting stylus. For instance, a steel-style cutting stylus may be selected, with appropriate surface noise and responsiveness emulated in the audio recording. Or a ruby cutting stylus, with an emulation of better audio results, or even a tungsten wedge or cone cutting stylus, with emulation of commensurate audio results.

Stylus effects may be added by overlaying an audio track of a given cutting head and/or stylus created by cutting silence into a given record medium, e.g., cutting into a given plastic record, dub plate, or wax. Preferably, the overlayed audio track is randomized for each use so that the same surface noises don't occur at the same point in all record booth sessions utilizing that effect. For instance, the overlayed audio track may be started at a random point for each use, or otherwise seeded with a random seed value. In another embodiment, samples of actual blank surface recordings may be randomly mixed and blended into the audio track to appear random.

Moreover, the record medium may be selected by the record booth user to fine-tune the audio effects such as stylus effects.

In a preferable embodiment, each, or all, video effect filters and audio effect filters may be purchased from the record booth server, or suitable other server or App store. When used in different combinations, the video filters and audio filters result in hundreds of different combination possibilities, adding to a unique expression of a record booth session made in a given wireless device record booth.

Preferably, as an aid to selection of a particular combination of audio elements (i.e., filters), the user is provided with a sample audio output from the speaker of their wireless device record booth as they are contemplating a particular audio filter combination.

Ideally a default video/audio filter combination is provided for a given record booth of a particular type. As additional record booth filter combinations are purchased, the associated video and audio filters become available to the user for mixing and matching to create customized effects.

For instance, the microphone, cutting head and cutting stylus similar to those originally found in a 1947 Voice-O-Graph record booth may ideally be provided by default. Additional filter combinations associated with the 1957 Voice-O-Graph record booth, and with the 1960s Voice-O-Graph record booth, may be added as a purchased premium item. With the audio and video filter combinations included with each of the 1947, 1957 and 1960s Voice-o-Graph record booth, the user of the wireless device Record Booth may mix and match prior to initiation of a given Record Booth session, and have that mixed-and-matched combination applied for all future Record Booth Sessions until changed.

Preferably, particularly as the mix-and-match combination varies from any of the pre-combined filters for the 1947, 1957 or 1960s Voice-o-Graph, an easy single-selection to bring the user back to the home or default filter combination for a given model Voice-o-Graph (e.g., for the 1947 Voice-O-Graph) is also provided.

An exemplary combination of video and audio filters to emulate use of the 1947 model Voice-O-Graph may include a record booth skin of an actual 1947 Voice-O-Graph, an audio filter associated with a 78 rpm 3 mil stylus, and a low end magnetic cutting head, with a video filter associated with a 1940s style TV.

### Metadata

Preferably, the stored video (or audio) record booth session files include in metadata a record of any/all video and audio options used, including the record booth skin selected, all audio filters used, and all video filters used.

### Streaming of Record Booth Session

The record booth server preferably makes use of a streaming engine, e.g., a WOWZA™ streaming engine.

Alternatively, the record booth sessions may be presented via an established streaming media mechanism. For instance, the record booth sessions may be presented to the masses, e.g., using an established video streaming service such as PERISCOPE™, www.twitch.tv, etc. Record booth sessions are streamed on one or more channels. Separate streaming channels may be established based on category of music style, geographic location, language, etc. Additional streaming channels may be subject related, such as ‘open mike’ with record booth sessions relating to topics of the day, a specific social event such as a Graduations, Blue Star Heroes for a video stream of greetings to a soldier overseas on deployment, etc.

Other use of category may be implemented within the principles of the present invention. For instance, the category may be freely defined by those mobile device record booths when recording a record booth session. The category may, if desired, include a prefix to the category, e.g., “vogTodays Debate”, with “vog” being the prefix. Or a designated keyboard character may be used such as &TodaysDebate, or \hat{ }TodaysDebate. Within a channel such as Graduations, a category specific to a particular school may be set by any user and mirrored by other users wanting their record booth sessions to be joined in the video same category-specific video stream. Thus, within a Graduations channel, a user may set/define a new category called \hat{ }BCCHighSchool, and all record booth sessions carrying that same category will be included in the video stream for Graduations/\hat{ }BCCHighSchool. In this way, a continuous uninterrupted video stream of record booth sessions each of limited length (e.g., 65 seconds) can be enjoyed of various graduates saying what they will miss most about their time at the school, etc. A download may be made available of the entire video stream, as of a given specific time such as when the \hat{ }BCCHighSchool category expires (e.g., after 7 days; after 30 days, etc.) Similarly, if the channel is Blue Star Heroes, a category specific to a particular soldier such as \hat{ }LiamBarry may be set by any user, and mobile device record booths may record their own unique record booth sessions into that channel and category, and have their greetings to Liam Barry concatenated into a continuous video stream for entertainment of Liam and all.

When setting the category for a record booth session, the record booth mobile device may prompt with current categories within the selected channel. The current categories may be presented in currently trending order. Preferably a search bar is provided by the mobile device record booth to enable search for a current category. Alternatively, the mobile device making a record booth session may define a new category within the selected channel.

The record booth mobile device in watching mode provides a selection of channel, and within the channel the ability to turn category filtering ON or OFF. If category filtering is OFF in watching mode, all record booth sessions within the selected channel are available for placement in a video stream to the mobile device record booth. If category filter is ON in watching mode, record booth sessions are further filtered to only those that meet the selected category.

The record booth sessions network may be global.

### Social Network Rating

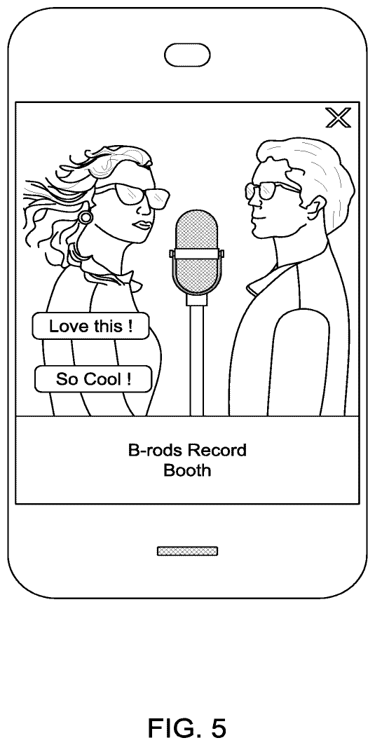

FIG. 5 shows an exemplary screen shot of a live record booth session being watched at one of a plurality of listening/watching wireless device (e.g., smartphone devices such as an iPhone), in accordance with the principles of the present invention.

In particular, as shown in FIG. 5, record booth sessions are preferably passively and/or actively RATED by the watching and listening public.

Passive rating may be calculated by any suitable manner, e.g., as a measure of the number of record booths who have watched the sourcing record booth, a length of time that record booth sessions have been watched from a given record booth, etc.

The number of listening/watching record booths at a time when a given record booth session is streamed also adds to a passive rating for a given record booth session. For instance, an increase in a number of listening/watching record booths achieved from start to finish of a given record booth session adds proportionately to a rating for that given record booth session. Similarly, a decrease in a number of listening/watching record booths achieved from start to finish will detract proportionately from the rating for that given record booth session.

Active rating may be implemented via ‘gold records’ (i.e. ‘likes’) attributed by listeners and watchers. The active rating may be obtained both from a number of ‘gold records’ or ‘likes’ attributed to a sourcing record booth, as well as to a number of ‘gold records’ or ‘likes’ attributed to the specific record booth session being watched as it is being watched.

The active rating is preferably dynamic, tallying ‘votes’ from all sources as the record booth session is played live, such that as a particular great record booth session is being watched, a flurry of positive ratings may cause listening/watching record booths (configured to accept such switching based on rating) to switch to the streaming channel carrying that record booth session.

Alternatively, or additionally, other social media may be utilized for active rating, e.g., TWITTER™ with a specific hashtag including an identity of a specific record booth session and/or its sourcing record booth.

Preferably a visual icon is presented on the user interface of the watching/listening record booth for easy single-touch rating either directly to the record booth server, or via an external social media source such as via TWITTER™.

A play list of video streams selected and played on the wireless device record booth is maintained, together with icons to enable single-click rating before and after the relevant video stream was viewed/listened to on that wireless device. Preferably, after a given wireless device has rated a given video stream, the voting icon is disabled for that wireless device to vote any more on that given video stream. Disabling of the rating icon may be indicated in any suitable manner, e.g., by disappearing or by dimming substantially.

“Best of” Hour

Highest rated record booth sessions are queued for re-presentation in a more special forum, for instance, a ‘Best Of’ hour each evening with the 65 seconds (or even shorter clips, e.g., 30 second clips) of the highest-rated record booth sessions over, e.g., the past 24 hours.

The ‘Best Of’ re-presentation of the best live record booth sessions may be reformatted for presentation on a large screen, for display in a lounge, living room, etc. Authorization for re-presentation is preferably obtained from the user of the record booth upon initial upload when the record booth app is first installed.

Rewards may be implemented to credit the account of certain record booths. For instance, a credit of a given amount may be made to the account of a given record booth upon being selected for inclusion in a “Best Of” hour or the like.

### Group Record Booth Session

The present invention can be implemented to permit a plurality of users the ability to be grouped together in a common virtual record booth, online and connected together, with each having their own wireless record booth app recording synchronously at the same time into a common live video and/or audio stream. One of the record booths is designated as the controlling record booth, providing payment to start the record booth session, for association of the record booth name with the video and/or audio stream, etc.

Invitations to other wireless device record booths are preferably initiated from the controlling record booth, and accepted by the accompanying record booths. The live video and/or audio stream of the resultant record booth session is uploaded to the record booth server by the controlling record booth.

The user interface of each accompanying record booth (i.e., all users that are “in the booth”) is started by the controlling record booth, with timing signals, etc. synchronized among all participating record booths.

### E-Record Greeting

A wireless record booth may optionally send a virtual vinyl record (i.e., an e-record) to any one or more designated email address(es). Similar to an e-greeting card, a designated recipient need not be a wireless record booth, but preferably the e-record includes a link to download the record booth app should the recipient not already have the record booth app loaded on the receiving wireless device.

The e-record is preferably an audio file in any suitable compressed format, e.g., MP3, etc. Metadata preferably includes an image of a vintage Voice-O-Graph type record, and/or vintage record booth. Alternatively, the recipient may receive a link to download the audio or video file associated with the record booth session sent as an e-record greeting.

### On Location Life Size Record Booths

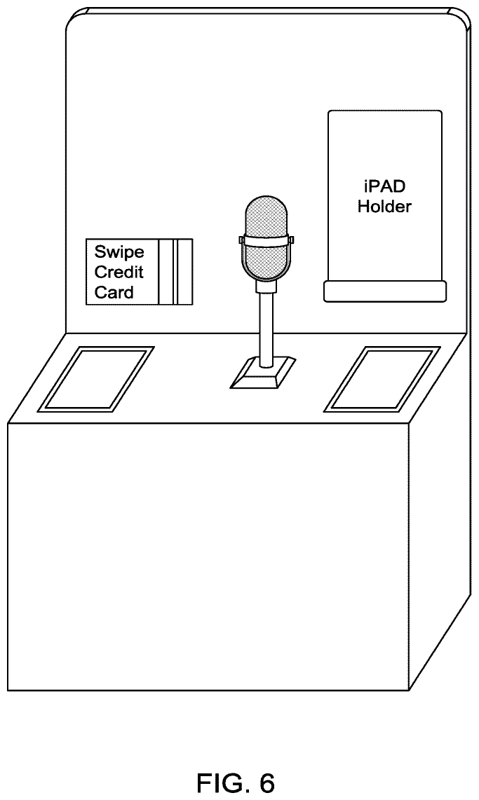

FIG. 6 shows an exemplary life-size record booth built in a style, e.g., of a 1947 Voice-O-Graph record booth, in accordance with the principles of the present invention.

In particular, life size replicas of the cabinet of a vintage Voice-O-Graph record booth, e.g., the 1947 model Voice-O-Graph record booth, may be built and put on location at select record stores, etc. Preferably the vintage replica record booth shell has a dedicated iPad with the record booth app running. An external microphone installed in the replica record booth may be used instead of the mic integrated within the wireless device used to host the record booth app. A physical instruction backglass may be implemented in the replica record booth, with signaling of actual light bulbs behind which being controlled by signalling from the record booth app running on the iPad or the like. External coin drop or credit card input may also be implemented and interfaced with the iPad running the record booth app.

The present invention is applicable to social networks in general. The invention lends itself to provide a venue for a contest for crowning a best record booth session.

The present invention provides a record booth session network in a way which provides numerous points for revenue generation, ensuring both a thriving social network for record booths, as well as income sufficient to sustain the costs of the network required to provide such a social network. For instance, revenue generating points for those recording a record booth session include, for example, a cost to the initial download and installation of a record booth application; a fee to record a record booth session (e.g., a 25 c token fee, billed monthly.) Longer length record booth sessions may be purchasable (e.g., 50 c for 2:10, etc.) A plastic record may be made from the live record booth session, and mailed to the user.

For those who only listen and watch others' recording booth sessions, access to video of record booth sessions may be provided to premium services members who pay a monthly fee, whereas audio may be provided free to all. Also, advertising revenue may be generated with watermarks injected into the record booth session.

Any required copyright licenses may be built into price, e.g., jukebox license, streaming engine license, etc.

### Record Booth Social Network

### Features and Requirements

The record booth app creates a social network wherein 65 second fair use sessions of all app users are streamed LIVE for the masses (per authorized agreement upon initial installation of the Record Booth app in the user's phone).

The Record Booth app provides an opportunity (for those who step into their own personal wireless device record booths) to be heard and/or watched in a social network environment!

The Record Booth provides numerous points for revenue generation, ensuring both a thriving social network for those recording in the record booth, as well as income sufficient to sustain the costs of the network required to provide such a social network to those watching others recording.

Revenue generating points for those recording a record booth session include, for example, a cost to the initial download and installation of a record booth application; a fee to record a record booth session (e.g., a 25 c token fee, billed monthly.) Longer length record booth sessions may be purchasable (e.g., 50 c for 2:10, etc.) A plastic record may be made from the live record booth session, and mailed to the user.

Revenue generating points for those who only listen and watch others' recording booth sessions may include on-demand access to past video of record booth sessions may be provided to premium services members who pay a monthly fee. (i.e., LIVE is free, on demand is premium)

Advertising revenue may be generated from watermarks injected into the video watched by others.

Any required copyright licenses may be built into price, e.g., jukebox license, streaming engine license, etc.

All configurable options are controlled by a server so that premium services can be enabled, etc.

The Record Booth lends itself to viral growth, particularly in conjunction with contests to crown a best record booth session.

### Initial Installation

Most, if not all, installation values are given a default so that the user can immediately skip entry and use the record booth right away.

Each Record Booth app is uniquely named by the phone owner. If a name is already within a database at the record booth server, the input name is rejected and a prompt is provided for another name.

A default unique name is provided automatically, until the user takes the time to change the record booth name to something they prefer. Suggestion is to use a numbering system such as: “RBxxxxxxx”.

Famous names, trademarked names, etc. are individually verified and indicated to listeners as being certified, e.g., using a check mark aside the record booth name, etc.

Login credentials, upon initial installation, record booth name created, checked for uniqueness at the server. Password protected. name and password are remembered and not asked again.

Record booth settings are maintained in a profile, stored locally. Up to 10 profiles may be saved.

User accepts authorized agreement to permit streaming of record booth session, upon initial installation of the Record Booth app in the user's phone.

All users are given an initial pile of TOKENS with installation of Record Booth app. Specific number is configurable, set to say 10 tokens initially.

### Main Page

Depicts an image of a 1947 Voice-O-Graph record booth to one side, and an image of a stack of Voice-O-Graph records next to one on a record player on the other, with a visual to invite selection of either RECORDING STUDIO mode (by touching the image of the record booth), or selection of RECORD PLAYER mode (by touching the image of the record player).

A small Record Booth logo is located in the bottom of the image, in the middle. When selected, you enter the fine print page that lists the REVISION NO of the app, and links to:
About Us:
Check for Update:
Terms of Use:
Privacy Policy:
FAQS:
Social Network sites (facebook, twitter)
Contact Us:
Advertising Inquiries:

### Recording Studio Mode

The GUI of the RECORDING STUDIO mode of record booth is a functional depiction of the inside of a particular model of the Voice-O-Graph record booth, e.g., the inside of the 1947 Voice-O-Graph record booth.

Quick use of the Record Booth app by a first-time user is to be facilitated, meaning that the app starts up with defaults sufficient to enable a new user to see it work right away.

If initiation information is missing, an icon asking user to input information (like naming their record booth, etc.) is requested BUT NOT REQUIRED TO PROCEED.

A gear is depicted as an icon for selection by user to enter an ARTISTIC EFFECTS page (see herein below)

The number of tokens remaining is shown visually in GUI, near the coin entry of the record booth, and is reduced by one for each use of the record booth.

If NO TOKENS remaining, when the user attempts to ENTER RECORD BOOTH, a PURCHASE TOKENS page is instead presented.

### Purchase Tokens Page

Only entered if no tokens remain.

Prompted input of payment method (PAYPAL or credit card). Information stored locally only (not on record booth server).

Token price is configurable, initially set to $0.25 each.

Option to bill purchased tokens monthly.

Sub-page to show ACCOUNT information, and payment history

### Enter Record Booth

The record booth user interface importantly uses the front-facing camera of the phone to video record the record session. Thus, the video image will typically be of one or more persons singing or speaking in front of the wireless device record booth.

The LENGTH of the record booth session is configurably set (by the admin). Default is 65 seconds. Longer time possible for premium users.

### Optional Data Input

A shadowed area at bottom of record booth image is provided, with “TITLE” lightly printed therein (image of booth is seen through the box) to enable the user to type in a name for the session. A reasonable but limited number of characters permitted (e.g., 64?), scrolls to left as you get to end of box.

A translucent CATEGORY wheel shown just below the name, with present choices. Language is English by default, if selected, many other languages provided as an option, which then replaces the choice of “English” on the category wheel thereafter, until changed. Default is A CAPELLA. Initial categories (configurably changed by admin) include, e.g.:
A CAPELLA
W/INSTRUMENT
SPEAKING
COMEDY
ORIGINAL SONG
Sub-categories may include, e.g.:
   ALL/general
ROCK
POP
COUNTRY
A general category relating to LANGUAGE of the recording: ENGLISH, etc.
MONTHLY CONTEST ENTRY

### Start

To start the record booth, the user preferably taps a visual depiction of a coin slide or coin entry plate in the graphical user interface showing the inside of a 1947 Voice-O-Graph record booth to ‘insert coin’ and start the record booth.

Once started, the record booth cannot be stopped. If app is closed during a record booth session, token is lost.

The record booth visually depicts an animation (or actual video) of a view through the viewing port of a record blank being loaded onto the turntable of the relevant model of Voice-O-Graph record booth. The perspective of the displayed image shifts to one looking down into the viewing port. Animation can be eliminated (by configuration).

The record blanks are shown as a black blank disk with a label. Default is black. Options are clear, or any basic color. Label on record is an image, configured by admin, to permit corporate sponsorship.

Actual sounds of a real 1947 Voice-O-Graph record booth may be output for realism during the animation. (configurable on/off)

Visual signals light in sequence on the depicted instruction “backglass” of the user interface displayed on the display screen of the wireless device, similar to the signaling in a real 1947 Voice-O-Graph recording studio, including:
“STUDIO IN OPERATION” lights when token entered.
“GET READY” arrow lights as the record blank is being loaded;
“65 SECONDS TO GO” lights at start of record booth session.
Also, a red RECORDING WHEN LIT light is illuminated when the record booth
session starts, and stays lit until end of record booth session.
“30 SECONDS TO GO” light;
“WARNING, 10 SECONDS TO GO” light;
“STOP! RECORDING COMPLETE” light.

Record booth sessions are 65 seconds in length.

As an additional guide, a nixie tube countdown clock is shown above the RECORDING WHEN LIT light, starting at “1:05” and counting down to “0:00”.

After recording the record booth session, that recording record booth preferably displays a queued position, or approx. time to live presentation on a given presentation channel, indicating approximately when the record booth session will be played live to other users.

### Post Recording

The record booth session is a LIVE video stream uploaded to the Record Booth server—not stored locally on the wireless device then significantly later uploaded by the user. To the extent that the live video stream must be buffered/stored locally for a short period of time while or just before upload to the Record Booth server, the buffer/storage is made invisible to the user and occurs entirely in the background. A significant delay is avoided between the recording of the record booth session, and upload to the record booth server.

Audio only of the record booth session is saved locally to an audio file (with ICON inserted into metadata as if an album cover), such that it may be located along with other music on their handset, and later played back whenever they want, serving as a record booth session playback function.

After completion of recording, a prompt is presented to the user interface asking if they want a 45 rpm record made. If so, they are taken to MAILED 45 rpm RECORD page.

### Mailed 45 Rpm Record Page

Appropriate payment is made via PAYPAL or cc. Since cc and PAYPAL information is locally stored, it is pre-filled in.

Input boxes for billing address (if cc) and mailing address. For efficiency, a last-entered mailing address is pre-filled in for the user to confirm.

### Artistic Effects Page

### Record Booth “Skins”

The record booth emulates any of a plurality of different style vintage record booths. Default record booth ‘skin’ that emulates the look of an actual 1947 model of the Voice-o-Graph record booth.

Alternative ‘skins’ may be chosen, such as a ‘skin’ that emulates or evokes an actual 1957 model of the Voice-O-Graph record booth. Or that emulates or evokes an actual 1960s model of the Voice-O-Graph record booth.

Or that evokes an imaginary model of the Voice-O-Graph that was not actually manufactured.

With each different skin includes new mechanism animation associated with that different model of the Voice-o-Graph.

### Video Effects

A visual software filter effect may be selected. Availability of filters is configurable (and likely a premium service)

Selected visual software filter is applied against the live video to add the relevant visual effects to the video. (UP TO PROGRAMMER is whether the visual filter is applied at handset, or at record booth server.)

Default may be NO visual filter. Video effect filters may be configured for purchase from the record booth server, or suitable other server or App store.

Currently envisioned video filters include:
a resulting video stream that appears to have been filmed with 35 mm film;
or 8 mm film
or through a fisheye lens
or to adjust colors to have a sunburnt look
or to adjust colors to have a watercolor look
or to adjust colors to be hot or over saturated
or to adjust film to have an aged look
or to appear as though video is being played on a 1940s style TV (e.g., black and white, rounded CRT edges, rastered, etc.)
or to appear as though video is being played on a 1960s early color TV (film noir/sound noir, less rounded edges, rastered).
or to appear as though video is being played on a 1970s TV (to have a Technicolor appearance—may go with Technisound

To aid selection of a particular video filter, the user is provided with an image from the front-facing camera on their smartphone (e.g., iPhone) using a contemplated video filter as they are selecting the given video filter.

Video filters are configurable, and may be a premium service, or purchased as a separate item via interaction with the record booth server or suitable app store.

### Audio Effects

An audio software filter effect may be selected. Availability of filters is configurable (and likely a premium service.)

Selected audio software filter is applied against the live audio to add the relevant audio effects to the video. (UP TO PROGRAMMER is whether the audio filter is applied at handset, or at record booth server.)

Default may be NO audio filter. Audio effect filters may be configured for purchase from the record booth server, or suitable other server or App store.

Currently envisioned audio filters include:

### Microphone

Selection of a type microphone having known frequency characteristics. (For purposes of the record booth app, for now differences between the volume output by different microphones is ignored.) E.g.:
bullet harmonica mic with cutoff freq of about 5,500 Hz
1950s Elvis style mic with cutoff freq of about 16,000 Hz

The actual frequency response curves of the selected microphone are applied against the audio to produce the desired audio filter.

### Cutterhead

Selection of a type cutterhead having known frequency characteristics. E.g.:
1940s Shure magnetic cutterhead
1950s Astatic magnetic cutterhead
1950s B.B.C. Grampian cutterhead

The actual frequency response curves of the selected cutterhead are applied against the audio to produce the desired audio filter.

### Cutting Stylus

Record surface noises or other subtlties are added as an audio effect via selection of a particular style cutting stylus. For instance, a steel-style cutting stylus may be selected, with appropriate surface noise and responsiveness emulated in the audio recording. Or a ruby cutting stylus, with an emulation of better audio results, or even a tungsten cutting stylus, with emulation of commensurate audio results.

Stylus effects may be added by overlaying an audio track of a given cutting stylus. The overlayed audio track is randomized for each use so that the same surface noises don't occur at the same point in all record booth sessions utilizing that effect. For instance, the overlayed audio track may be started at a random point for each use, or otherwise seeded with a random seed value. If possible, samples of actual blank surface recordings may be randomly mixed and blended into the audio track to appear random.

Default is no selection of cutting stylus such that the audio is not filtered. Options include:
steel stylus;
ruby stylus
tungsten stylus

All audio filters are configurable, and may be a premium service, or purchased as a separate item via interaction with the record booth server or suitable app store.

When used in different combinations, the video filters and audio filters result in hundreds of different combination possibilities, adding to a unique expression of a record booth session made in a given wireless device record booth.

As an aid to selection of a particular combination of audio elements (i.e., filters), the user is provided with a sample audio output from the speaker of their wireless device record booth as they are contemplating a particular audio filter combination.

A default video/audio filter combination is provided for a given record booth of a particular type. As additional record booth filter combinations are purchased, the associated video and audio filters become available to the user for mixing and matching to create customized effects.

For instance, the microphone, cutting head and cutting stylus similar to those originally found in a 1947 Voice-O-Graph record booth are provided by default. Additional filter combinations associated with the 1957 Voice-O-Graph record booth, and with the 1960s Voice-O-Graph record booth, may be added as a purchased premium item.

With the audio and video filter combinations included with each of the 1947, 1957 and 1960s Voice-o-Graph record booth, the user of the wireless device Record Booth may mix and match prior to initiation of a given Record Booth session, and have that mixed-and-matched combination applied for all future Record Booth Sessions until changed.

As the mix-and-match combination varies from any of the pre-combined filters for the 1947, 1957 or 1960s Voice-o-Graph, an easy single-selection to bring the user back to the home or default filter combination for a given model Voice-o-Graph (e.g., for the 1947 Voice-O-Graph) is also provided.

An exemplary combination of video and audio filters to emulate use of the 1947 model Voice-O-Graph includes a record booth skin of an actual 1947 Voice-O-Graph, an audio filter associated with a 78 rpm 3 mil stylus, and a low end magnetic cutting head, with a video filter associated with a 1940s style TV.

### Metadata

The stored video and audio files of the record booth session include in metadata a record of any/all video and audio options used, including the record booth skin selected, all audio filters used, and all video filters used.

A visual LINER NOTE/ICON (one sided), if uploaded through the record booth, is displayed as an ICON on the watchers screen during AUDIO ONLY presentation, and/or used as an icon when watchers are searching ON DEMAND selections.

The same ICON is used thereafter, and associated with all record booth sessions from the relevant record booth, until changed.

### Group Record Booth Session

A plurality of wireless device record booths may be grouped together in a common virtual record booth, online and connected together, with each having their own wireless record booth app recording synchronously at the same time into a common live video and/or audio stream.

One of the record booths is the initiating record booth, providing payment to start the record booth session, etc. Same price as for a single person in the record booth, but capability is configurable (and likely a premium service.)

The initiating record booth outputs invitations to other named wireless device record booths. The user inputs the name of any/all other participant record booths.

When a recipient of an invitation accepts the invitation, their audio is mixed with the audio in the initiating record booth (and also output for the user to hear).

The user interface of each accompanying record booth (i.e., all users that are “in the booth”) is started by the controlling record booth, with timing signals, etc. synchronized among all participating record booths.

### E-Record Greeting

A wireless record booth may enter an optional E-RECORD GREETING page in which E-RECORD GREETING option is chosen (configurable option), and up to 6 recipient record booths are identified. Recipient record booths are presented with a notification of the E-record greeting, both the next time they enter the RECORD PLAYER mode, but also out-of-band via text.

Email delivery of the audio file is presented as an option.

Similar to an e-greeting card, a designated recipient need not be a wireless record booth, but preferably the e-record includes a link to download the record booth app should the recipient not already have the record booth app loaded on the receiving wireless device.

The e-record is an audio file in any suitable compressed format, ideally MP3.

Metadata included with the e-record greeting includes the ICON provided by the record booth, if available. If not, the metadata includes an image of a vintage Voice-O-Graph type record.

Record Player mode

### Main Page

Record Player mode is an easy, passive, continuous experience where a default video stream is immediately presented to the user, to immediately engage them. Thus, the record player main page jumps directly into a full screen default streaming channel (e.g. a streaming channel looping the “BestOf” hour).

SWIPE RIGHT on record player main page to jump to the MATRIX SELECTION page.

SWIPE LEFT on record player main page to jump to the ON DEMAND search page.

For all modes: When new full screen stream started, translucent “[category] [title]” appears over video in translucent white text, and fades out. E.g.,
ROCK
“Bethesda Blues from my garage”
   or
ORIGINAL SONG
“Queequay”

Video stream is to be full screen, with AUDIO/VIDEO toggle, VOLUME, and “[category] [title]” appearing translucently on top after screen is tapped (and disappearing after screen tapped again). (feature available on all pages where video/audio is presented.)

The specific categories of currently live video streams presented for choice by the user is DYNAMIC, and can be changed at any time by the admin of the record booth server.

If AUDIO/VIDEO toggle is set to video, the streams are downloaded to handset as video; If AUDIO/VIDEO toggle is set to audio only, the streams are downloaded to handset as audio only; If AUDIO/VIDEO toggle setting is changed from video to audio, the audio begins immediately for the currently playing stream (without waiting to rebuffer an audio only file)

Preferably, the AUDIO continues to play as the wireless device is navigated to other non-audio apps, e.g., email, etc.

### Play List

A play list of video streams selected and played on the wireless device record booth is maintained, together with icons to enable single-click rating before and after the relevant video stream was viewed/listened to on that wireless device. Preferably, after a given wireless device has rated a given video stream, the voting icon is disabled for that wireless device to vote any more on that given video stream. Disabling of the rating icon may be indicated in any suitable manner, e.g., by disappearing or by dimming substantially.

Matrix Selection page

Swipe right from record player main page to get to Matrix selection page; swipe left to return to record player main page (if not automatically returned upon selection of full screen video stream).

A MATRIX page is provided where up to 12 video streams are shown together as a matrix. This is streamed as a single video to the handset. One tap on any portion of the screen attributed to a given video lets audio from that selected video stream play to the user, while video stream remains the matrix. Two taps (or long press) and that video stream is selected and goes full screen.

The number of video streams in the matrix is configurable by admin, from 2 to 12.

Over each video stream in the matrix, the CATEGORY is written (white text, translucent) (enable/disable configurable by user.)

Over each video stream in the matrix, the NUMBER of current watchers of each stream is written (yellow text, translucent) so that a popularity of all video streams shown in the matrix may be observed (enable/disable configurable by user.)

In an alternative embodiment, the currently highest rated stream is outlined in, e.g., a red border, or otherwise highlighted.

### On Demand Page (Configurable Access)

Left swipe from record player main page to get to On Demand page; swipe right to return to record player main page (thus returning to the previously selected live stream).

On-Demand search of past record booth sessions.

A default is to search ALL record booths (your own and others), or select to search only your own past record booth sessions

Search criteria (dropdown search menu):
Name of record booth
Title
Category
Date recorded
Location

If toggle is set to video, the on-demand streams are downloaded to handset as video.

If toggle is set to audio only, the on-demand streams are downloaded to handset as audio only.

If a custom ICON image file was uploaded by the recording record booth, that ICON is presented as an album cover, along with record booth name, title, and any other meta data input by recording record booth, as an aid to searching.

### Record Booth Server/Cloud

All current record booth sessions are presented for listening (or viewing) in a suitable category streaming channel. The particular stream that is downloaded to a particular watching record booth (and whether it is video or audio only) is determined by the particular watching record booth.

The streaming channels present live record booth sessions of a common category, queued one after another, queued in order received by the record booth server.

If any record booth session includes a significantly long silent or blank section (e.g., 5 seconds of silence), that record booth session is presumed to have ended early and is automatically terminated. The next record booth session is started immediately.

### Admin Page Provided

used to set network configurable parameters
used to add/delete video streams
used to generate statistics report (number of users, number or record booth sessions, number views, etc.)
used to generate users/revenue report over a designated period of time.
used to generate downloads report (number of downloads over a designated period of time)

### Super-Admin Page Provided

used to configure weighting of ratings factors
used to activate various premium features, and to set pricing.
used to administer software updates
used to create admin users, edit admin passwords
used to configure PayPal payment settings

### Favorite Record Booths

Users can ‘favorite’ record booth names on their listening/watching record booth so that when that ‘favorited’ record booth appears in any available streaming channel, the listening/watching record booth will automatically switch to that video stream carrying their ‘favorite’ record booth as it begins (preferably a configurable option). In this way, a given listening/watching record booth will be able to listen to/watch all record booth sessions from ‘liked’ record booths.

If the listening/watching record booth is not currently active, yet a record booth session with ‘favorite’ status is about to be played, the wireless device is provided with an out-of-band message such that a text message, tweet, or other notification (mode and address information is configurable) suggesting that the record booth app be started to hear/watch the upcoming record booth session. A link is provided with the out-of-band message such that the record booth app may be started and steered to play the ‘favorited’ record booth session with a single click.

A page is provided (right swipe from Matrix selection page) that lists any currently queued record booth sessions of ‘liked’ record booths. (access is configurable, and likely a premium service)

A page is provided (left swipe from On Demand page) that lists any past record booth sessions of ‘liked’ record booths currently available ‘on demand’. (access is configurable, and likely a premium service.)

### ‘Red Booth’ Feature

A page is provided to define a RED BOOTH option (ala RED ZONE Football on TV) whereby a profile is setup to select between all available video streams, and thus enable automatic switching between streams, even mid-session.

Profile option for RED BOOTH: An Enable/Disable option to move to the video stream currently carrying the highest rating record booth session playing. A minimum hysteresis time (configurable by user, default 10 seconds) is built in to avoid quick switches between video streams.

Profile option for RED BOOTH: An Enable/Disable option to move to the video stream currently carrying a FAVORITE record booth's session. Favorite record booth sessions are played in their entirety in RED BOOTH mode. If another favorite record booth's session begins while a first favorite record booth's session is still playing, in RED BOOTH mode the video stream automatically switches to the new favorite record booth's session.

### Social Network Rating

Record booth sessions are both passively and actively RATED as they are streamed. (weighting of each factor in rating is configurable by Admin)

The RATING is dynamic, continuously tallying ‘votes’ from all sources as the record booth session is played live, such that as a particular great record booth session is being watched, a flurry of positive ratings may cause listening/watching record booths (configured in the ‘RED BOOTH’ mode to accept such switching based on rating) to switch to the streaming channel carrying that record booth session.

The RATING is calculated at the record booth server/cloud.

### Passive Rating

Passive Rating FACTOR: The number of record booths watching a record booth session adds to a passive rating for a given record booth session.

Passive Rating FACTOR: A MEDIAN rating is maintained for each networked record booth over a period of time (admin configurable amount of time), which adds to the passive rating.

Passive Rating FACTOR: A delta of the number of record booths watching a particular record booth session from start to finish. For instance, an increase in a number of listening/watching record booths achieved from start to finish of a given record booth session adds to a passive rating for that given record booth session. Similarly, a decrease in a number of listening/watching record booths achieved from start to finish detracts (or at least does not add) to the passive rating for that given record booth session.

Passive Rating FACTOR: A MEDIAN of the past 5 sessions (admin configurable number) from a given record booth.

Passive Rating FACTOR: How quickly a user device indicates a ‘like’ of a given record booth session after it has started is used as an indication of a user's interest in that record booth session. For instance, if a user device selects ‘like’ of a given record booth session within the first 20 seconds of play of a 65 second record booth session, that can be used as an indication of extreme ‘like’, and thus can be an added passive rating factor.

Passive rating FACTOR: The geographic diversity of a universe of user devices that have ‘liked’ a given record booth session may be used as an indication of broader-range appeal. Thus, available location information may be used to ascertain a geographic distance from the record booth that recorded the given record booth session. For instance, user devices registered as being located in other states other than the state in which the given record booth that made the record booth session, if they have ‘liked’ a given record booth session, may be taken as a broader range of appeal, and thus may add to the passive rating FACTOR.

### Active Rating

Active Rating FACTOR: ‘gold records’ (i.e. ‘likes’) attributed by listeners and watchers (multiplied by a configurable parameter if the voting record booth has the voted record booth as a ‘favorite’.)

Active Rating FACTOR: Rating via TWITTER is enabled, using a specific hashtag including an identity of a specific record booth session and/or its sourcing record booth.

Active Rating FACTOR: A visual rating icon is presented on the user interface of the watching/listening record booth for easy single-touch rating when watching a video stream in full screen mode. The visual rating icon is preferably visible in a lower corner of the full screen video.

### “Best Of” Hour

Highest rated record booth sessions over the past 24 hours are queued for re-presentation in a more special forum, for instance, a ‘Best Of’ hour assembled each evening, and looped for 24 hours, on a BEST OF stream.

The ‘Best Of’ re-presentation of the best live record booth sessions may be reformatted for access through a web portal, for display in a lounge, living room, etc. Authorization for re-presentation is obtained from the user of the record booth upon initial installation of the record booth app.

Rewards/payment are made to credit the account of record booths selected for inclusion in a ‘BestOf’ hour. For instance, a credit of a given amount, or a given number of FREE tokens, may be made to the account of a given record booth upon inclusion in a “Best Of” hour.

### Sponsored Contests

In a sponsored contest embodiment, a splash page is shown upon initial startup of the Record Booth app, showing a vintage record booth and a billboard advertising an upcoming or present sponsored contest, e.g., a week-long contest to win a certain prize. From there a user may enter the contest, receive special ‘coins’ for entry of record booth sessions made therewith into one or more video streams dedicated to contest participants. The Record Booth otherwise enters the ‘matrix’ view page where a number of streams are shown (and/or contest streams), the stream with current highest rating being outlined in red or other suitable color.

Special coins may be provided or purchased by entrants in the contest. To attract sponsors, revenue from the special coins may be shared with the sponsor of the contest.

In other embodiments, an entrant may purchase as many special coins as desired. Also, in other embodiments, multiple coins may be entered into the record booth to record a longer record booth session, e.g., two coins for 130 seconds, etc. A contestant purchases specially encoded quarters that place record booth sessions paid for with that quarter into a stream dedicated to that contest. The quarters preferably appear in the graphical user interface ((GUI) with contest logo on them.

In one use case, a contest winner receives play of their record booth session (or a professionally recorded song of theirs) on a radio or satellite radio station. The modern take on the talent contest is that the public gets to see the contest sessions, self-filtering with ratings to formulate a best of stream. Built-in Entertainment! Sort of like a miniaturized and modern take on reality talent contests where the public has access to the many thousands of auditions live as they happen, and can watch just the best sessions, or get deeper into watching or listening to some of the other streams if they want.

### On Location Life Size Record Booths (Future)

In the FUTURE, life size replicas of the cabinet of a vintage Voice-O-Graph record booth, e.g., the 1947 model Voice-O-Graph record booth, may be built and put on location at select record stores, etc.

Porting of the following signals is to be planned for future use EXTERNAL to the handset:

An external microphone installed in the replica record booth may be input to the phone jack of a handset, and an external speaker in the replica record booth may be output to.

External coin drop or credit card payment (to a local vendor, or input to the physical replica booth) may be accepted via the Internet, from the record booth server instructing the record booth to start.

The instruction backglass light signaling is to be ported via the Internet to an IP address associated with the replica record booth, to synchronize the instruction signals.

While described with respect to certain embodiments, disclosed features may be removed within the principles of the present invention. For instance, in the WATCHING mode, the record booth mobile device may have three pages: LIVE NOW, NEW, and BEST.

The following is an algorithm design specification for an exemplary record booth program in a user device such as an iPhone 6 available commercially from APPLE™, in accordance with an embodiment of the present invention.

While the invention has been described with reference to the exemplary embodiments thereof, those skilled in the art will be able to make various modifications to the described embodiments of the invention without departing from the true spirit and scope of the invention.

What is claimed is:

1. A social entertainment device formed by a non-transitory social entertainment computer program on a wireless device which when executed by the wireless device operates to output social entertainment media containing a hashtag for inclusion in arranged play related to a search on a display of the wireless device, the social entertainment device being configured to:
cause push of a notification to at least one of a plurality of other social entertainment devices to announce a new recording from the social entertainment device;
intermittently-recording the new recording on the social entertainment device using a camera of the wireless device, the new recording having a total fixed maximum recorded length of time of no more than one of a plurality of selectable fixed time lengths, the plurality of selectable fixed time lengths each being a multiple of a shorter one of the plurality of selectable fixed time lengths, and at least one of the plurality of possible fixed time lengths being no more than 65 seconds;
transforming an image from the camera of the social entertainment device using a selectable video effect for display as an aid in selecting the selectable video effect from among a plurality of possible selectable video effects;
transforming video of the new recording by application of the selectable video effect;
associate the new recording for arranged play with recordings of some of the plurality of other social entertainment devices, the new recording having a watermark applied thereto;
immediately upon startup of the social entertainment computer program on the wireless device a recording by another of the plurality of other social entertainment devices is played with watermark on the display of the social entertainment device; and
recordings of a sub-plurality of the plurality of other social entertainment devices are played on the display of the social entertainment device.

2. The social entertainment device according to claim 1, wherein the social entertainment device is further configured to:
email access to a recording of any of the sub-plurality of the plurality of other social entertainment devices to any email address.

3. The social entertainment device according to claim 1, wherein the camera is a front-facing camera.

4. The social entertainment device according to claim 1, wherein the camera is interfaced to the wireless device.

5. The social entertainment device according to claim 1, wherein the wireless device is a smart phone.

6. The social entertainment device according to claim 5, further comprising a microphone in the smart phone.

7. The social entertainment device according to claim 1, wherein:
the new recording recorded on the social entertainment device is played on displays of at least one of the plurality of other social entertainment devices that received the push of the notification of the new recording from the social entertainment device.

8. The social entertainment device according to claim 1, wherein the social entertainment device is further configured to:
rearrange the arranged sequence of the recordings of the some of the plurality of other social entertainment devices.

9. The social entertainment device according to claim 1, wherein the social entertainment device is further configured to:
enable a user of the social entertainment device to define a new video channel for play of the new recording by creating a new hashtag.

10. The social entertainment device according to claim 1, wherein:
the search includes currently defined hashtags.

11. The social entertainment device according to claim 1, wherein
the social entertainment device automatically switches the display to a new recording recorded by another of the plurality of other social entertainment devices selected to be a ‘favorite’ of the social entertainment device, once such another social entertainment uploads the new recording recorded by the another of the plurality of other social entertainment devices.

12. The social entertainment device according to claim 1, wherein
the hashtag is contained within meta data associated with the new recording.

13. The social entertainment device according to claim 1, wherein the fixed maximum recorded length of time setting includes an alternative setting being no more than 30 seconds.

14. The social entertainment device according to claim 13, wherein the fixed maximum recorded length of time setting includes another alternative setting being no more than 130 or more seconds.

15. The social entertainment device according to claim 1, wherein the fixed maximum recorded length of time setting includes an alternative setting being no more than 130 or more seconds.

16. The social entertainment device according to claim 6, further comprising:
transforming audio of the new recording recorded using the microphone by causing application of at least a selected one of a plurality of audio effects to the new recording.

17. The social entertainment device according to claim 9, wherein
the new hashtag is contained within meta data associated with the new recording.
